(19) United States
(12) Patent Application Publication
(10) Pub. No.: US 2006/0270059 A1
(43) Pub. Date: Nov. 30, 2006

(54) Modular printing of biopolymer arrays

(76) Inventors: Xiaohua C. Huang, Mountain View, CA (US); Eric M. Leproust, San Jose, CA (US); Bill J. Peck, Mountain View, CA (US); Lawrence J. DaQuino, Los Gatos, CA (US); Kyle J. Schleifer, Mountain View, CA (US); Stanley P. Woods, Cupertino, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/140,084

(22) Filed: May 27, 2005

(51) Int. Cl. B01L 3/00

(52) U.S. Cl. 436/180

(57) ABSTRACT

Methods and apparatus are disclosed for preparing an array of polymeric compounds on a substrate. Drops of polymer subunits are dispensed to a surface of a substrate from two or more drop dispensing modules wherein each module comprises dispensers for dispensing a respective polymer-forming reagent. At least two of the modules and a substrate are brought into drop dispensing relationship in at least one step prior to conducting the step of preparing the surface for repeating the drop-dispensing step. Next, the surface is subjected to reagents to prepare the surface for repeating the drop-dispensing step. The above steps are repeated for a sufficient number of cycles to prepare the array of polymeric compounds.

### BACKGROUND OF THE INVENTION

This invention relates in general to drop dispensing devices and methods of using the same. In some embodiments the invention relates to the manufacture of substrates having bound to the surfaces thereof a plurality of chemical compounds, such as biopolymers. In some embodiments, the invention relates to the manufacture of microarray slides where the biopolymers comprise one or more non-standard monomers such as, for example, monomer analogs.

In the field of diagnostics and therapeutics, it is often useful to attach species to a surface. One important application is in solid phase chemical synthesis wherein initial derivatization of a substrate surface enables synthesis of polymers such as oligonucleotides and peptides on the substrate itself.

The arrays may be microarrays created on the surface of a substrate by in situ synthesis of biopolymers such as polynucleotides, which include oligonucleotides, polypeptides, which include oligopeptides, polysaccharides, which include oligosaccharides, etc., and combinations thereof, or by deposition of molecules such as oligonucleotides, cDNA and so forth. In general, arrays are synthesized on a surface of a substrate by one of any number of synthetic techniques that are known in the art. In one approach, for example, the substrate may be one on which a single array of chemical compounds is synthesized. Alternatively, multiple arrays of chemical compounds may be synthesized on the substrate, which is then diced, i.e., cut, into individual assay devices, which are substrates that each comprise a single array, or in some instances multiple arrays, on a surface of the substrate.

Biopolymers comprising one or more monomer analogs have recognized, and as yet unrecognized, utility in analyses involving such biopolymers. For example, incorporation of nucleotide analogs into polynucleotides may have both existing and new applications in the field of genomics. Oligonucleotide arrays in which at least some of the oligonucleotides comprise one or more nucleotide monomers may be utilized to conduct multiplex analysis of multiple variant sites in one or more different target polynucleotides at the same time. Substrate bound oligomer arrays, particularly oligonucleotide arrays, may be used in screening studies for determination of binding affinity.

Current drop dispensing devices for synthesizing arrays on a surface of a substrate usually utilize a module having five printheads, one each for each of the standard nucleotide monomer reagents and one for activator such as tetrazole. One approach to synthesizing oligonucleotides comprising one or more nucleotide analogs might be to design a printing system with additional printheads corresponding to the number of different monomer analogs that might be incorporated into respective oligonucleotides of an array. Since the number of different monomer analogs may be comparatively large depending on the complexity of the analysis, the design, manufacture and operation of a printing system having a significantly increased number of printheads may be complicated.

There is, therefore, a need for apparatus and methods for preparing high-density biopolymer arrays where at least some of the biopolymers comprise one or more monomer analogs. Desirably, the apparatus and methods are compatible with existing printing technology for printing arrays of biopolymers and with simplicity of design and operation.

### SUMMARY

One embodiment of present invention is directed to a method for preparing an array of polymeric compounds on a substrate. Drops of polymer forming reagents are dispensed to a surface of a substrate from two or more drop dispensing modules, each comprising dispensers for dispensing a respective polymer-forming reagent. Each of the modules and the substrate are brought into drop dispensing relationship in the above step, or in at least one repetition of the above step, prior to conducting the step of preparing the surface for repeating the drop-dispensing step. Next, the surface is subjected to reagents to prepare the surface for repeating the drop-dispensing step. The above steps of dispensing and preparing the surface are repeated to prepare the array of polymeric compounds.

In some embodiments of the above method, arrays are prepared on at least two separate substrates. In the drop dispensing step, or in at least one repetition of the drop dispensing step, a dispensing protocol is employed in which one drop dispensing module dispenses polymer forming reagents to the surface of one of the substrates and the other drop dispensing module dispenses polymer forming reagents to the other of the substrates and then the dispensing protocol is reversed prior to the step of preparing the surface of the substrate for the next drop dispensing step. In some embodiments the reagents are dispensed simultaneously from each of the modules to respective substrates.

In some embodiments of the above method, arrays are prepared on multiple substrates. The drop dispensing modules dispense polymer-forming reagents to different substrates until all polymer subunits are deposited for a particular step. A dispensing protocol is employed wherein drop dispensing modules are brought into dispensing relationship with respective substrates to dispense polymer forming reagents, reagents are dispensed and another drop dispensing relationship different from that above is established among the drop dispensing modules and the substrates and the dispensing protocol is repeated until all polymer forming reagents are deposited for a particular step. In some embodiments the reagents are dispensed simultaneously from each of the modules to respective substrates.

Some embodiments of the present invention are directed to apparatus for preparing an array of polymeric compounds on a substrate from multiple polymer subunits. The apparatus comprise two or more drop dispensing modules, each comprising dispensers for dispensing a respective polymer-forming reagent. In some embodiments the apparatus comprise a module moving mechanism adapted to move the drop dispensing modules relative to a surface of a substrate on the substrate mount to bring each of the drop dispensing modules into drop dispensing relationship with the surface. In some embodiments, the apparatus comprises a substrate mount and a substrate moving mechanism adapted to move the substrate to a processing station and back to the substrate mount. In some embodiments the module moving mechanism is adapted to move the drop dispensing modules relative to a surface of a substrate on the substrate mount to bring each of the drop dispensing modules into drop dispensing relationship with the surface.

### BRIEF DESCRIPTION OF THE DRAWINGS

The following figures are included to better illustrate the embodiments of the apparatus and techniques of the present invention. The figures are not to scale and some features may be exaggerated for the purpose of illustrating certain aspects or embodiments of the present invention.

FIG. 1 is a perspective view of a substrate bearing multiple arrays.

FIG. 2 is an enlarged view of a portion of FIG. 1 showing some of the identifiable individual regions (or “features”) of a single array of FIG. 1.

FIG. 3 is an enlarged cross-section of a portion of FIG. 2.

FIG. 4 is a schematic depiction of an example of an embodiment of a method in accordance with the present invention.

FIG. 5 is a schematic depiction of another example of an embodiment of a method in accordance with the present invention.

FIG. 6 is a schematic depiction of another example of an embodiment of a method in accordance with the present invention.

FIG. 7 is a schematic depiction of an embodiment of an apparatus in accordance with the present invention.

### DETAILED DESCRIPTION OF SPECIFIC EMBODIMENTS

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

In some embodiments, the present invention provides methods for preparing substrates having an array of features bound to at least one surface of the substrate. The features generally comprise chemical compounds, usually, polymeric chemical compounds, for example, biopolymers, formed from polymer subunits, for example, nucleotide reagents or amino acid reagents.

For example, various ways may be employed to introduce reagents for producing an array of polynucleotides on the surface of a substrate such as a glass substrate. Such methods are known in the art. One in situ method employs inkjet printing technology to dispense appropriate phosphoramidite reagents and other reagents necessary for forming the polynucleotide onto individual sites on a surface of a substrate. Oligonucleotides are synthesized on a surface of a substrate in situ using phosphoramidite chemistry. Solutions containing nucleotide monomers and other reagents as necessary such as an activator, e.g., tetrazole, are applied to the surface of a substrate by means of, for example, piezo ink-jet technology or thermal ink-jet technology. Individual drops of reagents are applied to reactive areas on the surface using a piezo ink-jet type nozzle or a thermal ink-jet type nozzle. The surface of the substrate may have an alkyl bromide trichlorosilane coating to which is attached polyethylene glycol to provide terminal hydroxyl groups. These hydroxyl groups provide for linking to a terminal primary amine group on a monomeric reagent. Excess of non-reacted chemical on the surface is washed away in a subsequent step.

In embodiments of the present invention, two or more drop dispensing modules are employed wherein the modules each comprise dispensers for dispensing a respective polymer forming reagent. Each of the dispensers generally comprise many nozzles or ejectors for dispensing drops of polymer forming reagents. The number of modules is dependent on the number and nature of the polymer forming reagents that are utilized in a particular synthesis, on the nature of the polymeric compound to be synthesized, and so forth. In general, the number of modules is determined by dividing the number of polymer forming reagents by the number of drop dispensers in each module, and then rounding up to a whole number where necessary. In many embodiments, the number of drop dispensing modules is at least 2, at least 3, at least 4, at least 5, at least 6, at least 7, at least 8, at least 9, at least 10, or more and may be in the range of about 2 to about 20, about 2 to about 10, about 2 to about 6, and so forth.

An important consideration with respect to the present embodiments is that more than one drop dispensing module is utilized to dispense drops of polymer forming reagent. Furthermore, in some embodiments a drop dispensing protocol is employed wherein, in at least one drop dispensing step of the repetitive cycles involved in the synthesis of biopolymers on the surface of a substrate, at least two drop dispensing modules are brought into drop dispensing relationship with the surface prior to the step of the cycle of preparing the surface for another drop dispensing step for dispensing polymer forming reagents in a drop dispensing step of a next or subsequent cycle.

In some embodiments of the invention, drops of polymer forming reagents are dispensed to a surface of a substrate from two or more drop dispensing modules wherein at least two of the modules consist of no more than six dispensers for dispensing a respective polymer-forming reagent. In many embodiments, the number of drop dispensers is five or six.

The modules are generally a housing or structural element to which the drop dispensers are attached and may comprise components for providing liquid communication between the drop dispensers and a source of reagents, which may or may not be part of the module. The drop-dispensing module is a housing structure designed to hold/secure a drop dispenser or an assembly thereof. The housing is therefore configured to engagingly fit with or connect to a drop dispenser or an assembly thereof. In principle, the housing is configured to fit with any type of drop dispenser assembly, including pulse jet assemblies, such as piezoelectric and thermal pulse jet assemblies.

The overall dimensions of the module may vary, particularly with respect to the nature of the drop dispenser or an assembly thereof that it is designed to hold. However, in many embodiments, the module is configured to have a length ranging from about 20 to about 300 mm, or about 30 to about 200 mm, or about 40 to about 100 mm, a height ranging from about 10 to about 200 mm, or about 20 to about 100 mm, or about 30 to about 80 mm, and a width ranging from about 10 to about 200 mm, or about 15 to about 150 mm, or about 20 to about 100 mm.

The drop dispensing modules usually comprise a fluid delivery manifold such as, e.g., a rectangular support with an actuating mechanism such as a piezoelectric crystal or resistive element or the like. An orifice plate, dispenser face plates such as, e.g., nozzle plates or the like, are affixed in such a manner that drops can be dispensed from the dispensers to the surface of a substrate. Each of the dispensers may also comprise an adjuster for adjusting the orientation of the dispenser so that drops are accurately delivered to the surface of the substrate. Each of the dispensers may also comprise cables for communicating to a computer or the like. Accordingly, each of the dispensers may be in the form of a dispenser assembly, which comprises the aforementioned faceplate, adjuster, cables and the like.

At least two of the modules each consist of a number of dispensers that is determined by the physical limits such as, e.g., size and the like, of a holding element such as, e.g., a fluid delivery manifold or a rectangular support, of the module and the physical limits such as, e.g., size and the like, of each of the dispenser face plates, and so forth. For purposes of illustration, consider a holding element of a module, e.g., rectangular support, to which the dispensers are secured having dimensions of about 150 mm in width, about 220 mm in length and about 10 mm in height. Furthermore, consider the size of the dispenser faceplate such as, e.g., a nozzle faceplate, that can be accommodated by the above module size to be about 5 mm by about 70 mm, by about 200 mm in length. With the above size considerations in mind, in some embodiments the modules of the present methods and apparatus consist of no more than six dispensers and all or, where the number of modules permit, all less one, or all less two, or all less three, etc., of the modules may consist of no more than six dispensers. The number of dispensers for each module, considering the present physical limits of the modules and the dispensers, is at least 2 and is in the range of about 2 to about 6, about 2 to about 5, about 3 to about 6, about 3 to about 5, about 4 to about 6, about 4 to about 5, about 5 to about 6, and so forth. It should be noted that, as technology advances and the size of the dispensers and/or the size of the holding elements of the modules changes, the number of dispensers per module can be adjusted accordingly.

One specific embodiment of a module consists of five or six dispensers or heads, which may be of a type commonly used in an ink jet type of printer. Each head carries hundreds of ejectors or nozzles to deposit droplets. In the case of heads, each ejector may be in the form of an electrical resistor operating as a heating element under control of a processor (although piezoelectric elements could be used instead). Each orifice with its associated ejector and a reservoir chamber, acts as a corresponding pulsejet with the orifice acting as a nozzle. In this manner, application of a single electric pulse to an ejector causes a droplet to be dispensed from a corresponding orifice (or larger droplets could be deposited by using multiple pulses to deposit a series of smaller droplets at a given location). Certain elements of a suitable head can be adapted from parts of a commercially available inkjet print head devices available from Hewlett-Packard Co. However, other head configurations can be used as desired.

The modules may also include reagent sources or manifolds as well as reagent lines that connect the source to fluid dispensing nozzles and the like. The modules may also comprise one or more pumps for moving fluid and may also comprise a valve assembly and a manifold. The fluids may be dispensed by any known technique. Any standard pumping technique for pumping fluids may be employed in the dispensing device. For example, pumping may be by means of a peristaltic pump, a pressurized fluid bed, a positive displacement pump, e.g., a syringe pump, and the like.

Embodiments of the present approach permit the formation of polymeric compounds utilizing many more polymer forming reagents than previously recognized without employing larger and/or more cumbersome printing modules that are not readily adaptable to known printing apparatus and technology. For example, in the synthesis of oligonucleotide arrays, oligonucleotides may be formed on the surface of a substrate where the oligonucleotides comprise not only the standard four nucleotides but also one or more nucleotide analogs. Embodiments of the invention permit the synthesis to be carried out using multiple printing modules, which may be readily adapted to known printing apparatus and technology.

In many embodiments a dispensing protocol is employed that is determined by the number of substrates to which polymer forming reagents are to be dispensed and the number of drop dispensing modules utilized in a dispensing step. For example, arrays of polymers may be formed on a single substrate using a number of drop dispensing modules determined as discussed above. The protocol includes dispensing polymer forming reagents from each dispensing module until polymer forming reagents have been dispensed from the dispensing modules to the substrates to deposit the polymer forming reagents that are to be deposited in a drop dispensing step of at least one cycle (as discussed in more detail below) of the polymer synthesis. It will be appreciated that not all dispensers will necessarily dispense polymer-forming reagents in each step. The dispensers that dispense reagents in a particular step are determined by the polymer forming reagents that are to be added during the step in question. In addition, not all dispensing modules will necessarily dispense reagents in a particular drop-dispensing step. However, in at least one drop dispensing step of a cycle of the synthesis at least two of the modules and the substrate are brought into drop dispensing relationship prior to conducting the step of the synthesis cycle that involves preparing the surface for repeating a drop dispensing step in a subsequent cycle. It should be understood that more than two of the total number of drop dispensing modules up to the total number of modules may be brought into drop dispensing relationship with one or more substrates in the at least one step. This is dependent, for example, on the number of substrates on which arrays are to be synthesized, and so forth.

The phrase “drop dispensing relationship” as used above refers to bringing the dispensing module and the substrate into proximity such that drops of fluid may be dispensed to the surface of the substrate at one or more locations on the surface whether or not drops of fluid are actually dispensed to the surface of the substrate. For example, an apparatus and accompanying hardware (for example, a computer) and software (for example, a computer program product) may be programmed such that the dispensing modules and the substrates are brought into drop dispensing relationship in a predetermined pattern that is utilized during an entire synthesis. However, as mentioned above, in any one dispensing step, the reagents dispensed may not involve all of the dispensing modules. However, because of the programming of the apparatus, the drop dispensing modules each move into drop dispensing relationship with a substrate whether or not drops are actually dispensed. Of course, in some embodiments the apparatus may be programmed such that only the drop dispensing modules that are actually dispensing reagents in a particular step are brought into drop dispensing relationship. Conventionally, a single dispenser is assigned to deposit a single polymer-forming reagent such as a monomeric unit.

Embodiments of the present invention have particular application to the preparation of arrays of polymers on more than one substrate and, in some embodiments, to the simultaneous preparation of arrays of polymers on more than one substrate. The drop dispensing modules dispense polymer-forming reagents to different substrates sequentially until all polymer subunits are deposited for a drop-dispensing step of a cycle of the synthesis, which is sometimes referred to herein as a “particular cycle.” The term “particular cycle” refers to a cycle comprising the steps of dispensing drops of polymer forming reagents to predetermined locations on the surface of the substrate and subjecting the predetermined locations to reagents for preparing the locations for a next drop dispensing step. A drop dispensing step involves dispensing drops of a polymer forming reagent to predetermined locations on the surface of the substrate followed by dispensing drops of a different polymer forming reagent to other predetermined locations and so forth until all polymer forming reagents are dispensed for the dispensing step of a cycle of the synthesis. As discussed herein by way of example, desired polymer subunits are dispensed to extend a growing polymer chain of each polymer to be synthesized at a specific location on the surface of a substrate by one polymer subunit. For example, consider a cycle in the synthesis of oligonucleotides on the surface of a substrate. The growing chain for each oligonucleotide is 8 nucleotides in length. In a particular cycle, various nucleotide subunits are dispensed dropwise to predetermined locations on the surface of the substrate to extend the growing chain to 9 nucleotides in length. Accordingly, drops of one of the nucleotide reagents are dispensed to predetermined locations to add the ninth nucleotide at these locations and then drops of another nucleotide reagent are dispensed to other predetermined locations to add the ninth nucleotide at these other locations. The cycle of the synthesis is not complete until all locations have a ninth nucleotide. Each nucleotide addition to all of the locations is sometime referred to in the art as forming a layer. Thus, in each completed cycle a layer of nucleotides is formed on the surface of the substrate. In the example above, the cycle produced the ninth layer.

By “sequentially” is meant that each drop dispensing relationship among respective substrate surfaces follows the establishment of a previous drop dispensing relationship until all drop dispensing relationships between respective substrate surfaces have been established to deposit the reagents necessary for a particular cycle of the synthesis.

For example, by way of illustration and not limitation, assume that there are three dispensing modules 1, 2 and 3 and three substrates A, B and C on which arrays are to be constructed. In a particular step of the synthesis, a first round of dispensing is employed in which module 1 is brought into a drop dispensing relationship with substrate A, module 2 is brought into a drop dispensing relationship with substrate B and module 3 is brought into a drop dispensing relationship with substrate C. This may be accomplished simultaneously or non-simultaneously. After appropriate reagents are dispensed to locations on the surfaces of the substrates, a second round of dispensing is employed in which module 1 is brought into a drop dispensing relationship with substrate B, module 2 is brought into a drop dispensing relationship with substrate C and module 3 is brought into a drop dispensing relationship with substrate A. Again, after appropriate reagents are dispensed to the surfaces of the substrates, a third round of dispensing is employed in which module 1 is brought into a drop dispensing relationship with substrate C, module 2 is brought into a drop dispensing relationship with substrate A and module 3 is brought into a drop dispensing relationship with substrate B. Bringing the modules into drop dispensing relationship with the surfaces of the substrates and/of dispensing drops of polymer forming reagents to the surfaces of the substrates may be carried out simultaneously or non-simultaneously as discussed herein.

Accordingly, a dispensing protocol is employed wherein an initial drop dispensing relationship is established among dispensing modules and respective substrates to dispense polymer forming reagents and wherein dispensing relationships are sequentially established among modules and substrates that differ from the previous or prior dispensing relationship in separate rounds of dispensing reagents within a particular cycle. The dispensing protocol is carried out until all polymer forming reagents are deposited for a particular cycle and prior to exposing the surface of the substrate to reagents for preparing the growing polymer for conducting the next cycle of the synthesis. Accordingly, in many embodiments for “n” number of modules, there are “n” number of rounds of dispensing reagents in a particular cycle wherein different drop dispensing relationships are established between modules and substrates until all reagents are dispensed to all substrates for a particular cycle of the synthesis. Again, it will be appreciated that not all dispensers will necessarily dispense polymer-forming reagents in each cycle or dispense to each substrate in any one dispensing step of a cycle. The dispensers that dispense reagents in a particular cycle are determined by the polymer subunits that are to be added during the particular cycle. However, in at least one drop dispensing step at least two of the modules and the substrate are brought into drop dispensing relationship in at least one step of a cycle prior to conducting the step of preparing the surface for the next cycle of the synthesis by repeating the drop-dispensing step.

As mentioned above, the drop dispensing relationship, and/or the drop dispensing itself, between the drop dispensing modules and the respective substrates may be established and/or conducted simultaneously or non-simultaneously as long as in at least one drop dispensing step at least two of the modules and the substrate are brought into drop dispensing relationship in at least one step prior to conducting the step of preparing the surface for repeating the drop dispensing step. By the phrase “non-simultaneously” is meant any timing of establishing a drop dispensing relationship or dispensing drops other than simultaneously. Thus, the timing between the establishment of the drop dispensing relationship, and/or the drop dispensing itself, in any particular step may vary by about 0.01 seconds to about 2 seconds, by about 0.05 seconds to about 1.5 seconds, by about 0.1 seconds to about 1 second, and the like.

The phrase “dispensing protocol” includes the manner and timing of dispensing of drops of fluid to the surface of a substrate and of bringing dispensing modules into drop dispensing relationship with a surface of a substrate or with respective surfaces of substrates where multiple substrates are employed.

Following the dispensing step of a synthetic cycle, the surface is subjected to reagents to prepare the surface for repeating the drop-dispensing step. The above steps of dispensing reagents and preparing the surface of each cycle are repeated a sufficient number of times to synthesize the array of polymeric compounds. The nature of the reagents to prepare the surface for the next step is dependent on the nature of the polymers that are formed, on the nature of the polymer forming reagents and the synthetic procedure employed, and the like. For in situ fabrication methods, in many embodiments multiple different reagent droplets are deposited on the surface of a substrate at a given target location in order to form the final feature or polymer at that location. The in situ fabrication methods include those described in U.S. Pat. No. 5,449,754 for synthesizing peptide arrays, and in U.S. Pat. No. 6,180,351 and WO 98/41531 and the references cited therein for polynucleotides.

For example, an in situ method for fabricating a polynucleotide array typically follows, at each of the multiple different locations or addresses at which polymer features are to be formed, the same conventional iterative sequence used in forming polynucleotides from nucleoside reagents on a substrate by means of known chemistry. This iterative sequence can be considered as multiple ones of the following attachment cycle at each feature to be formed: (a) coupling an activated selected nucleoside (a monomeric unit) through a phosphite linkage to a functionalized substrate in the first iteration, or a nucleoside bound to the substrate (i.e. the nucleoside-modified substrate) in subsequent iterations; (b) optionally, blocking unreacted hydroxyl groups on the substrate bound nucleoside (sometimes referenced as “capping”); (c) oxidizing the phosphite linkage of step (a) to form a phosphate linkage; and (d) removing the blocking group (“deblocking”) from the now substrate bound nucleoside coupled in step (a), to generate a reactive site for the next cycle of these steps. In the above method, the coupling can be performed, for example, by depositing drops of an activator and phosphoramidite at the specific desired feature locations for the array. Capping, oxidation and deblocking can be accomplished by treating the entire substrate (“flooding”) with a layer of the appropriate reagent. The functionalized substrate (in the first cycle) or deprotected coupled nucleoside (in subsequent cycles) provides a substrate bound moiety with a linking group for forming the phosphite linkage with a next nucleoside to be coupled in step (a). Final deprotection of nucleoside bases can be accomplished using alkaline conditions such as ammonium hydroxide, in another flooding procedure in a known manner. Consistent with embodiments of the present invention, activator may be dispensed utilizing a dispenser of one of the drop dispensing modules discussed above.

The foregoing chemistry of the synthesis of polynucleotides is described in detail, for example, in Caruthers, Science 230: 281-285, 1985; Itakura, et al., Ann. Rev. Biochem. 53: 323-356; Hunkapillar, et al., Nature 310: 105-110, 1984; and in “Synthesis of Oligonucleotide Derivatives in Design and Targeted Reaction of Oligonucleotide Derivatives”, CRC Press, Boca Raton, Fla., pages 100 et seq., U.S. Pat. Nos. 4,458,066, 4,500,707, 5,153,319, and 5,869,643, EP 0294196, and elsewhere.

The phrase “polymer forming reagents” includes polymer subunits as well as other reagents necessary for adding a polymer subunit to a growing polymer chain on the surface of a substrate. Such other reagents include, for example, activator reagents, and the like. As may be appreciated, the nature of the other reagents depends on the nature of the polymers formed, the polymer forming reagents, and so forth.

A “polymer subunit” is a chemical entity that can be covalently linked to one or more other such entities to form an oligomer or polymer. The polymer subunit may be a monomer or a chain of monomers. Examples of monomers include nucleotides, amino acids, saccharides, peptoids, and the like and chains comprising nucleotides, amino acids, saccharides, peptoids and the like. The chains may comprise all of the same component such as, for example, all of the same nucleotide or amino acid, or the chain may comprise different components such as, for example, different nucleotides or different amino acids. The chains may comprise at least 2, at least 3, at least 4, at least 5, at least 6, at least 7, at least 8, at least 9, at least 10, and so forth, monomer units and may be in the range of about 2 to about 2000, or about 2 to about 200, or about 2 to about 100 monomer units. In general, the polymer subunits, for example, may have first and second sites (e.g., C-termini and N-termini, or 5′ and 3′ sites) suitable for binding of other like monomers by means of standard chemical reactions (e.g., condensation, nucleophilic displacement of a leaving group, or the like), and a diverse element that distinguishes a particular monomer from a different monomer of the same type (e.g., an amino acid side chain, a nucleotide base, etc.). The initial substrate-bound monomer is generally used as a building block in a multi-step synthesis procedure to form a complete polymer, such as in the synthesis of oligonucleotides, polynucleotides, oligopeptides, polypeptides, oligosaccharides, polysaccharides, and the like.

As referred to above, embodiments of the invention have particular application to substrates bearing oligomers or polymers. The oligomer or polymer is a chemical entity that contains a plurality of monomers. It is generally accepted that the term “oligomers” is used to refer to a species of polymers. The terms “oligomer” and “polymer” may be used interchangeably herein. Polymers usually comprise at least two monomers. Oligomers generally comprise about 6 to about 20,000 monomers, preferably, about 10 to about 10,000, more preferably about 15 to about 4,000 monomers. Examples of polymers include polydeoxyribonucleotides, polyribonucleotides, other polynucleotides that are C-glycosides of a purine or pyrimidine base, or other modified polynucleotides, polypeptides, polysaccharides, and other chemical entities that contain repeating units of like chemical structure. Exemplary of oligomers are oligonucleotides and oligopeptides. It is important to note that some skilled in the art classify oligonucleotides as containing less than a specified number of nucleotides such as 100 or less nucleotides and classify polynucleotides as containing more than a specified number of nucleotides such as more than 100 nucleotides. As used herein, the term polynucleotide includes oligonucleotides.

The present methods have particular application to the preparation of arrays comprising biopolymers. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions.

Polynucleotides are compounds or compositions that are polymeric nucleotides or nucleic acid polymers. The polynucleotide may be a natural compound or a synthetic compound. Polynucleotides include oligonucleotides and are comprised of natural nucleotides such as ribonucleotides and deoxyribonucleotides and their derivatives although unnatural nucleotide mimetics such as 2′-modified nucleosides, peptide nucleic acids and oligomeric nucleoside phosphonates are also used. The polynucleotide can have from about 2 to 5,000,000 or more nucleotides. Usually, the oligonucleotides are at least about 2 nucleotides, usually, about 5 to about 100 nucleotides, more usually, about 10 to about 50 nucleotides, and may be about 15 to about 30 nucleotides, in length. Polynucleotides include single or multiple stranded configurations, where one or more of the strands may or may not be completely aligned with another.

A nucleotide refers to a sub-unit of a nucleic acid and has a phosphate group, a 5 carbon sugar ring and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, the term “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides.

Preferred materials for the substrate on which the synthesis takes place are those materials that provide physical support for the chemical compounds that are deposited on the surface or synthesized on the surface in situ from subunits. The materials should be of such a composition that they endure the conditions of a deposition process and/or an in situ synthesis and of any subsequent treatment or handling or processing that may be encountered in the use of the particular array.

Typically, the substrate material is transparent. By “transparent” is meant that the substrate material permits signal from features on the surface of the substrate to pass therethrough without substantial attenuation and also permits any interrogating radiation to pass therethrough without substantial attenuation. By “without substantial attenuation” may include, for example, without a loss of more than 40% or more preferably without a loss of more than 30%, 20% or 10%, of signal. The interrogating radiation and signal may for example be visible, ultraviolet or infrared light. In certain embodiments, such as for example where production of binding pair arrays for use in research and related applications is desired, the materials from which the substrate may be fabricated should ideally exhibit a low level of non-specific binding during hybridization events. However, it should be noted that the nature of the transparency of the substrate is somewhat dependent on the nature of the scanner employed to read the substrate surface. Some scanners work with opaque or reflective substrates.

The materials may be naturally occurring or synthetic or modified naturally occurring. Suitable rigid substrates may include glass, which term is used to include silica, and include, for example, glass such as glass available as Bioglass, and suitable plastics. Should a front array location be used, additional rigid, non-transparent materials may be considered, such as silicon, mirrored surfaces, laminates, ceramics, opaque plastics, such as, for example, polymers such as, e.g., poly (vinyl chloride), polyacrylamide, polyacrylate, polyethylene, polypropylene, poly(4-methylbutene), polystyrene, polymethacrylate, poly(ethylene terephthalate), nylon, poly(vinyl butyrate), etc., either used by themselves or in conjunction with other materials. The surface of the substrate is usually the outer portion of a substrate.

The surface of the material onto which the chemical compounds are deposited or formed may be smooth and/or substantially planar, or have irregularities, such as depressions or elevations. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethylene amines, polyarylene sulfides, polysiloxanes, polyimides, polyacetates, and the like, where the polymers may be hetero- or homo-polymeric, and may or may not have separate functional moieties attached thereto (for example, conjugated). Various further modifications to the particular embodiments described above are, of course, possible. Accordingly, the present invention is not limited to the particular embodiments described in detail above.

The material used for an array substrate or substrate may take any of a variety of configurations ranging from simple to complex. Usually, the material is substantially rectangular and relatively planar such as, for example, a slide. In many embodiments, the material is shaped generally as a rectangular solid. As mentioned above, multiple arrays of chemical compounds are synthesized on a sheet, which is then singulated, such as, e.g., cut by breaking along score lines, into single array slides. The sheet of material may be of any convenient size depending on the nature of the equipment used, production lot size, production efficiencies, production throughput demands, and so forth. In some embodiments, the sheet of material is usually about 5 to about 13 inches in length and about 5 to about 13 inches in width so that the sheet may be divided into multiple single array substrates having the dimensions indicated below. The thickness of the substrate is about 0.01 mm to 5.0 mm, usually from about 0.1 mm to 2 mm and more usually from about 0.2 to 1. In a specific embodiment by way of illustration and not limitation, a wafer that is 6.25 inches by 6 inches by 1 mm is employed.

The surface of a substrate is normally treated to create a primed or functionalized surface, that is, a surface that is able to substrate the attachment of a fully formed chemical compound or the synthetic steps involved in the production of the chemical compound on the surface of the substrate. Functionalization relates to modification of the surface of a substrate to provide a plurality of functional groups on the substrate surface. By the term “functionalized surface” is meant a substrate surface that has been modified so that a plurality of functional groups are present thereon usually at discrete sites on the surface. The manner of treatment is dependent on the nature of the chemical compound to be synthesized and on the nature of the substrate surface. In one approach a reactive hydrophilic site or reactive hydrophilic group is introduced onto the surface of the substrate. Such hydrophilic moieties can be used as the starting point in a synthetic organic process.

In one embodiment, the surface of the substrate, such as a glass substrate, is siliceous, i.e., the surface comprises silicon oxide groups, either present in the natural state, e.g., glass, silica, silicon with an oxide layer, etc., or introduced by techniques well known in the art. One technique for introducing siloxyl groups onto the surface involves reactive hydrophilic moieties on the surface. These moieties are typically epoxide groups, carboxyl groups, thiol groups, and/or substituted or unsubstituted amino groups as well as a functionality that may be used to introduce such a group such as, for example, an olefin that may be converted to a hydroxyl group by means well known in the art. One approach is disclosed in U.S. Pat. No. 5,474,796 (Brennan), the relevant portions of which are incorporated herein by reference. A siliceous surface may be used to form silyl linkages, i.e., linkages that involve silicon atoms. Usually, the silyl linkage involves a silicon-oxygen bond, a silicon-halogen bond, a silicon-nitrogen bond, or a silicon-carbon bond.

Another method for attachment is described in U.S. Pat. No. 6,219,674 (Fulcrand, et al.). A surface is employed that comprises a linking group consisting of a first portion comprising a hydrocarbon chain, optionally substituted, and a second portion comprising an alkylene oxide or an alkylene imine wherein the alkylene is optionally substituted. One end of the first portion is attached to the surface and one end of the second portion is attached to the other end of the first portion chain by means of an amine or an oxy functionality. The second portion terminates in an amine or a hydroxy functionality. The surface is reacted with the substance to be immobilized under conditions for attachment of the substance to the surface by means of the linking group.

Another method for attachment is described in U.S. Pat. No. 6,258,454 (Lefkowitz, et al.). A solid substrate having hydrophilic moieties on its surface is treated with a derivatizing composition containing a mixture of silanes. A first silane provides the desired reduction in surface energy, while the second silane enables functionalization with molecular moieties of interest, such as small molecules, initial monomers to be used in the solid phase synthesis of oligomers, or intact oligomers. Molecular moieties of interest may be attached through cleavable sites.

A procedure for the derivatization of a metal oxide surface uses an aminoalkyl silane derivative, e.g., trialkoxy 3-aminopropylsilane such as aminopropyltriethoxy silane (APS), 4-aminobutyltrimethoxysilane, 4-aminobutyltriethoxysilane, 2-aminoethyltriethoxysilane, and the like. APS reacts readily with the oxide and/or siloxyl groups on metal and silicon surfaces. APS provides primary amine groups that may be used to carry out the present methods. Such a derivatization procedure is described in EP 0 173 356 B1, the relevant portions of which are incorporated herein by reference. Other methods for treating the surface of a substrate will be suggested to those skilled in the art in view of the teaching herein.

The devices and methods of the present invention are particularly useful for the preparation of individual substrates with an array of biopolymers. An array includes any one-, two- or three-dimensional arrangement of addressable regions bearing a particular biopolymer such as polynucleotides, associated with that region. An array is addressable in that it has multiple regions of different moieties, for example, different polynucleotide sequences, such that a region or feature or spot of the array at a particular predetermined location or address on the array can detect a particular target molecule or class of target molecules although a feature may incidentally detect non-target molecules of that feature.

Normally, the surface of the substrate opposite the surface with the array (opposing surface) does not carry any arrays. The arrays can be designed for testing against any type of sample, whether a trial sample, a reference sample, a combination of the foregoing, or a known mixture of components such as polynucleotides, proteins, polysaccharides and the like (in which case the arrays may be composed of features carrying unknown sequences to be evaluated).

Any of a variety of geometries of arrays on a substrate may be used. As mentioned above, an individual substrate usually contains a single array but in certain circumstances may contain more than one array. Features of the array may be arranged in rectilinear rows and columns. This is particularly attractive for single arrays on a substrate. The configuration of the arrays and their features may be selected according to manufacturing, handling, and use considerations.

Regardless of the geometry of the array on the surface of an individual substrate or on the surface of a sheet comprising a multiple of individual substrates, the arrays normally do not comprise the entire surface of the sheet or of the substrate. For sheets of material comprising a multiple of individual substrates, the sheet typically has a border along its longitudinal edges that is about 0.5 to about 3 mm wide, usually, about 1 to about 2 mm wide. In many embodiments, the border of the individual substrates obtained from the sheet has the same dimensions as the border for the sheet. In some embodiments one area of the individual substrate that is a non-interfeature area or a portion of a border or a combination thereof comprises an identifier such as, e.g., a bar code. It is often desirable to have some type of identification on the array substrate that allows matching a particular array to layout information, since array layout information in some form is used to meaningfully interpret the information obtained from interrogating the array.

As mentioned above, the surface of an individual substrate may have only one array or more than one array. Depending upon intended use, the array may contain multiple spots or features of chemical compounds such as, e.g., biopolymers in the form of polynucleotides or other biopolymer. A typical array on an individual substrate may contain more than ten, more than one hundred, more than five hundred, more than one thousand, more than fifteen hundred, more than two thousand, more than twenty five hundred features, more than 20,000, more than 25,000, more than 30,000, more than 35,000, more than 40,000, more than 50,000, more than 75,000, or more than 100,000 features. In many embodiments the number of features on the individual substrates is in the range of about 100 to about 100,000, about 1000 to about 100,000 and so forth. The features may occupy an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges.

Each feature, or element, within the molecular array is defined to be a small, regularly shaped region of the surface of the substrate. The features are arranged in a predetermined manner. Each feature of an array usually carries a predetermined chemical compound or mixtures thereof. Each feature within the molecular array may contain a different molecular species, and the molecular species within a given feature may differ from the molecular species within the remaining features of the molecular array. Some or all of the features may be of different compositions. Each array may contain multiple spots or features separated by spaces or areas that have no features. Such interfeature areas are usually present but are not essential. As with the border areas discussed above, these interfeature areas do not carry any chemical compound such as polynucleotide (or other biopolymer of a type of which the features are composed). Interfeature areas typically will be present where arrays are formed by deposition of polymer subunits, as described above. It will be appreciated though that the interfeature areas, when present, could be of various sizes and configurations.

### Specific Embodiments of Methods

Some embodiments of present invention are directed to methods for preparing an array of polymeric compounds on a substrate. Drops of polymer forming reagents are dispensed to a surface of a substrate from two or more drop dispensing modules wherein at least two of the modules consist of no more than six dispensers for dispensing a respective polymer-forming reagent. Each of the modules and the substrate are brought into drop dispensing relationship in the above step, or in at least one repetition of the above step, prior to conducting the step of preparing the surface for repeating the drop-dispensing step. Next, the surface is subjected to reagents to prepare the surface for repeating the drop-dispensing step. The above steps of dispensing and preparing the surface are repeated to prepare the array of polymeric compounds.

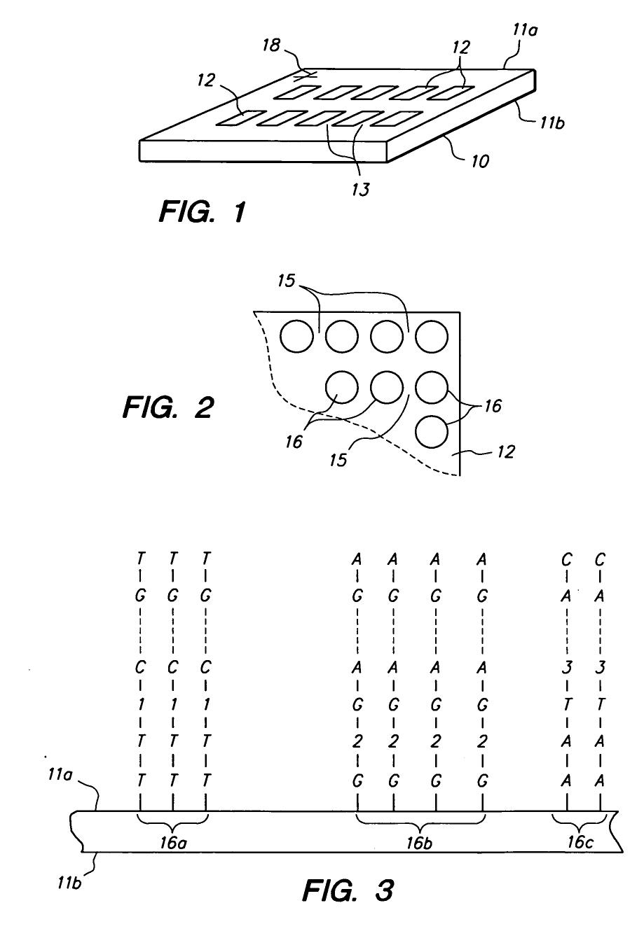

Referring to FIGS. 1-3, there is shown multiple identical arrays 12 (only some of which are shown in FIG. 1), separated by inter-array regions 13, across the complete front surface 11a of a single transparent substrate 10. However, the arrays 12 on a given substrate need not be identical and some or all could be different. Each array 12 will contain multiple spots or features 16 separated by inter-feature regions 15. A typical array 12 may contain from 100 to 100,000 features. All of the features 16 may be different, or some or all could be the same. Each feature carries a predetermined moiety (such as a particular polynucleotide sequence), or a predetermined mixture of moieties (such as a mixture of particular polynucleotides). This is illustrated schematically in FIG. 3 where different regions 16 are shown as carrying different polynucleotide sequences (where the numbers 1, 2 and 3 denote nucleotide analogs).

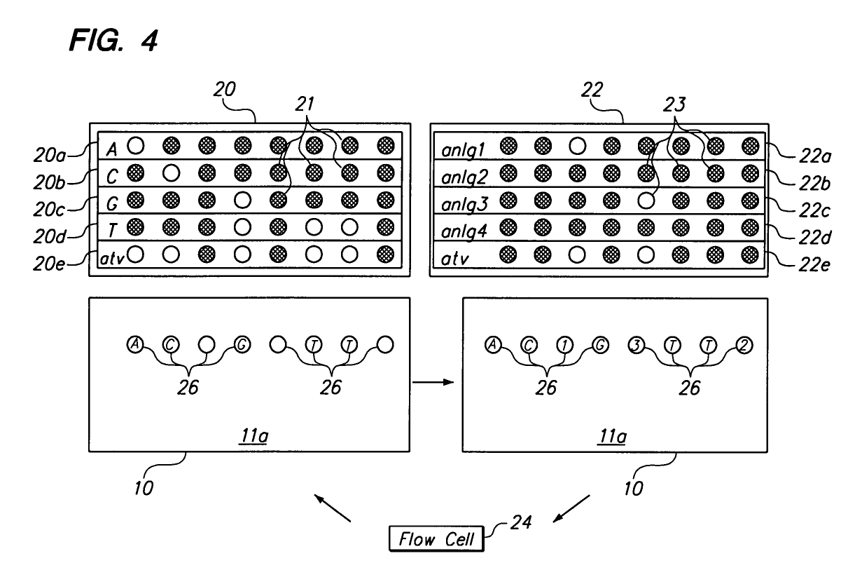

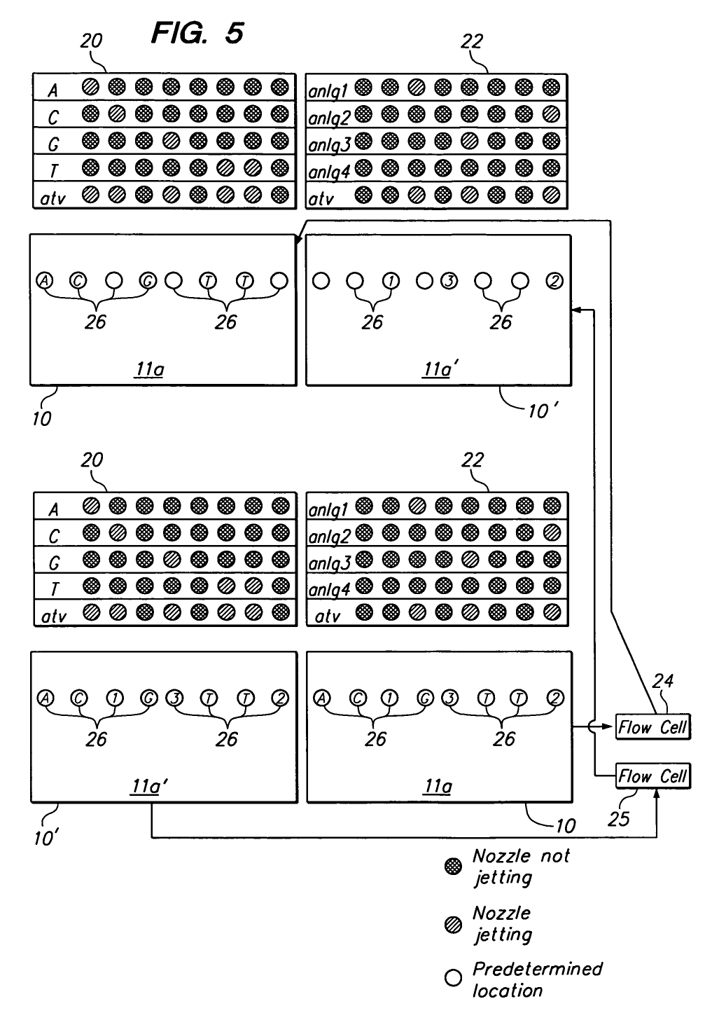

Examples of specific embodiments of the present methods will be discussed next with reference to the accompanying drawings. FIG. 4 depicts a method employing two drop dispensing modules 20 and 22, each having five dispensers 20a-20e and 22a-22e, respectively. Each of the dispensers comprises eight nozzles 21 and 23 respectively. Dispensers 20a-20d are disposed to dispense nucleotide monomer reagents for dA, dG, dC and dT, respectively. Dispenser 20e is disposed to dispense activator reagent (“atv”), which may be, for example, tetrazole. Dispensers 22a-22d are disposed to dispense nucleotide analog monomer reagents, namely, analogue 1, analogue 2, analogue 3 and analogue 4, respectively. Dispenser 22e is disposed to dispense activator reagent (atv). The nucleotide monomer reagents and the nucleotide analog monomer reagents are in the form of phosphoramidate reagents for synthesizing an array of polynucleotides on the surface of a substrate where some of the polynucleotides comprise nucleotide analogs.

In this example, a protocol in accordance with embodiments of the present invention includes dispensing the appropriate polymer forming reagents from dispensing module 20 followed by dispensing the appropriate polymer forming reagents from dispensing module 22 until all polymer forming reagents have been dispensed for a dispensing step of a particular cycle or layer of the polymer synthesis. Accordingly, dispensing module 20 and substrate 10 are brought into drop dispensing relationship whereupon drops of activator reagent are dispensed to predetermined locations 26 on surface 11a of substrate 10 followed by dispensing of a particular polymer forming reagents dA, dC, dG, dT, respectively. Next, dispensing module 22 and substrate 10 are brought into drop dispensing relationship and drops of activator are dispensed to predetermined locations on surface 11a of substrate 10 (not overlapped with the predetermined locations in the dispensing relationship between module 20 and substrate 10) followed by dispensing of a particular polymer forming reagents analogue 1, analogue 2 and analogue 3, respectively. Following the dispensing of reagents for the dispensing step of the cycle in question, substrate 10 is placed in flow cell 24 where it is subjected to various treatment steps such as, for example, blocking or capping, oxidation and deblocking as mentioned above. In this embodiment the treatment is accomplished by treating the entire substrate (“flooding”) with a liquid layer of the appropriate reagent. The above protocol is repeated in a next cycle to deposit the appropriate polymer forming reagents for the next cycle in the synthesis. The cycles or steps are repeated until the desired array has been synthesized. Final deprotection of nucleoside bases can be accomplished as discussed above thereby producing the final array product.

FIG. 5 depicts a method employing two drop dispensing modules 20 and 22, each having five dispensers 20a-20e and 22a-22e, respectively, as in the method discussed above with regard to FIG. 4. In this example, arrays are synthesized on two different substrates simultaneously. A protocol in accordance with embodiments of the present invention includes dispensing the appropriate polymer forming reagents from dispensing module 20 to substrate 10 simultaneously dispensing the appropriate polymer forming reagents from dispensing module 22 to substrate 10′ and switching the dispensing arrangement to dispense appropriate polymer forming reagents from dispensing module 22 to substrate 10 and simultaneously to dispense appropriate polymer forming reagents from dispensing module 20 to substrate 10′ until all polymer forming reagents have been dispensed for a dispensing step of a particular cycle of the polymer synthesis. The simultaneous dispensing of reagents from the two modules to the substrates is for purposes of illustration and not limitation. As mentioned above, dispensing of reagents may be carried out simultaneously or non-simultaneously as long as in at least one cycle of the synthesis polymer forming reagents are dispensed from the two modules to the two substrates in a dispensing step of the cycle.

In accordance with the embodiment of this example, dispensing module 20 and substrate 10 are brought into drop dispensing relationship whereupon drops of activator reagent are dispensed to predetermined locations on surface 11a of substrate 10 followed by dispensing of a particular polymer forming reagents dA, dC, dG and dT, respectively. Simultaneously, dispensing module 22 and substrate 10′ are brought into drop dispensing relationship whereupon drops of activator reagent are dispensed to predetermined locations on surface 11a′ of substrate 10′ followed by dispensing of a particular polymer forming reagents analogue 1, analogue 2 and analogue 3, respectively. Next, dispensing module 20 and substrate 10′ are brought into drop dispensing relationship and drops of activator are dispensed to predetermined locations on surface 11a′ of substrate 10′ followed by dispensing of a particular polymer forming reagents dA, dC, dG and dT, respectively. Simultaneously, dispensing module 22 and substrate 10 are brought into drop dispensing relationship whereupon drops of activator reagent are dispensed to predetermined locations on surface 11 a of substrate 10 followed by dispensing of a particular polymer forming reagents analogue 1, analogue 2 and analogue 3, respectively. Following the dispensing of reagents for the dispensing step this cycle, substrate 10 is placed in flow cell 24 where it is subjected to various treatment steps such as, for example, capping, oxidation and deblocking as mentioned above. Simultaneously, substrate 10′ is placed in flow cell 25 where it is subjected to various treatment steps such as, for example, capping, oxidation and deblocking as mentioned above. In this embodiment the treatment is accomplished by treating the entire substrate (“flooding”) with a liquid layer of the appropriate reagent. The above protocol is repeated in a subsequent cycle to deposit the appropriate polymer forming reagents for the next cycle in the synthesis. The cycles or steps are repeated until the desired arrays have been synthesized. Final deprotection of nucleoside bases can be accomplished as discussed above thereby producing the final array product.

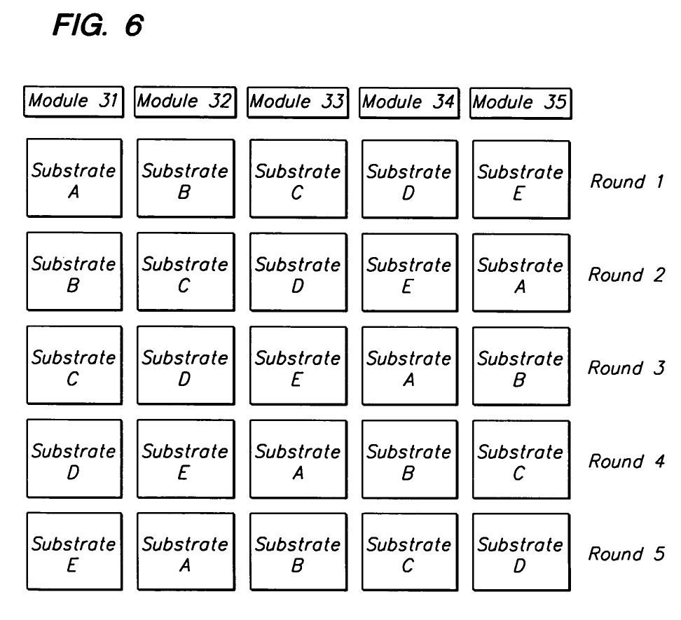

FIG. 6 depicts a method employing five drop dispensing modules 31-35, each having six dispensers, respectively (not shown) and five substrates A-E on which arrays are to be constructed. In a particular step of the synthesis, a first round (Round 1) of dispensing is employed in which module 31 is brought into a drop dispensing relationship with substrate A, module 32 is brought into a drop dispensing relationship with substrate B, module 33 is brought into a drop dispensing relationship with substrate C, module 34 is brought into a drop dispensing relationship with substrate D and module 35 is brought into a drop dispensing relationship with substrate E. This may be accomplished simultaneously or non-simultaneously. After appropriate reagents are dispensed to locations on the surfaces of the substrates, a second round (Round 2) of dispensing is employed in which module 31 is brought into a drop dispensing relationship with substrate B, module 32 is brought into a drop dispensing relationship with substrate C, module 33 is brought into a drop dispensing relationship with substrate D, module 34 is brought into a drop dispensing relationship with substrate E and module 35 is brought into a drop dispensing relationship with substrate A. Again, after appropriate reagents are dispensed to the surfaces of the substrates, a third round (Round 3) of dispensing is employed in which module 31 is brought into a drop dispensing relationship with substrate C, module 32 is brought into a drop dispensing relationship with substrate D, module 33 is brought into a drop dispensing relationship with substrate E, module 34 is brought into a drop dispensing relationship with substrate A and module 35 is brought into a drop dispensing relationship with substrate B. Again, after appropriate reagents are dispensed to the surfaces of the substrates, a fourth round (Round 4) of dispensing is employed in which module 31 is brought into a drop dispensing relationship with substrate D, module 32 is brought into a drop dispensing relationship with substrate E, module 33 is brought into a drop dispensing relationship with substrate A, module 34 is brought into a drop dispensing relationship with substrate B and module 35 is brought into a drop dispensing relationship with substrate C. Again, after appropriate reagents are dispensed to the surfaces of the substrates, a fifth round (Round 5) of dispensing is employed in which module 31 is brought into a drop dispensing relationship with substrate E, module 32 is brought into a drop dispensing relationship with substrate A, module 33 is brought into a drop dispensing relationship with substrate B, module 34 is brought into a drop dispensing relationship with substrate C and module 35 is brought into a drop dispensing relationship with substrate D. Bringing the modules into drop dispensing relationship with the surfaces of the substrates and/of dispensing drops of polymer forming reagents to the surfaces of the substrates may be carried out simultaneously or non-simultaneously as discussed herein.

Following the dispensing of reagents for the dispensing step (Round 1-Round 5) of this cycle, the substrates are placed into respective flow cells (not shown) where they are subjected to various treatment steps such as, for example, capping, oxidation and deblocking as mentioned above. In this embodiment the treatment is accomplished by treating the entire substrate (“flooding”) with a liquid layer of the appropriate reagent. The above protocol is repeated in a subsequent cycle to deposit the appropriate polymer forming reagents for the next cycle in the synthesis. The cycles or steps are repeated until the desired arrays have been synthesized. Final deprotection of nucleoside bases can be accomplished as discussed above thereby producing the final array product.

### Embodiments of Apparatus

Some embodiments of the present invention are directed to apparatus for preparing an array of polymeric compounds on a substrate from multiple polymer subunits. The apparatus comprises two or more drop dispensing modules as described above for dispensing respective polymer forming reagents. In some embodiments the apparatus comprise a module moving mechanism adapted to move the drop dispensing modules relative to a surface of a substrate on a substrate mount to bring each of the drop dispensing modules into drop dispensing relationship with the surface. In some embodiments, the apparatus comprises a substrate mount and a substrate moving mechanism adapted to move the substrate to a processing station and back to the substrate mount. In some embodiments the module moving mechanism is adapted to move the drop dispensing modules relative to a surface of a substrate on a substrate mount to simultaneously bring each of the drop dispensing modules into drop dispensing relationship with the surface.

The module moving mechanism is generally an automated device. Such automated devices comprise at least a means for precisely controlling the position of the drop-dispensing module with respect to a substrate surface. Examples of such means include, for example, an XYZ translational mechanism, e.g., an XYZ translational arm to which the module is rigidly fixed. In some embodiments the module moving mechanism also comprises means for firing the head. Such automated devices are well known to those of skill in the printing and document production art and are disclosed in U.S. Pat. Nos. 5,772,829; 5,745,128; 5,736,998; 5,736,995; 5,726,690; 5,714,989; 5,682,188; 5,677,577; 5,642,142; 5,636,441; 5,635,968; 5,635,966; 5,595,785; 5,477,255; 5,434,606; 5,426,458; 5,350,616; 5,341,160; 5,300,958; 5,229,785; 5,187,500; 5,167,776; 5,159,353; 5,122,812; and 4,791,435; the disclosures of which are herein incorporated by reference.

In some embodiments the module moving mechanism is adapted for moving a drop dispensing module for translation along an x-axis and/or a y-axis and/or a z-axis. This movement may be independent of the movement of the substrate mount along the respective axes, e.g., a y-axis. Translation along an x-axis provides for moving the dispensing device transversely to the direction of movement of the substrate mount (along the y-axis) and in position for dispensing of reagents to the surface of a substrate. In one approach the drop dispensing module is carried by a stage arrangement, which provides for the desired movement parameters. In this approach the dispensing module is secured to the stage, which is usually attached to a frame member of an apparatus. For example, in one approach the dispensing module may be carried by an orthogonal z-axis stage arrangement attached to an x-axis stage arrangement, which is attached directly to a rigid supporting beam off a base to which the substrate mount is secured. Other approaches for providing the dispensing device with desired movement capabilities may be employed.

To achieve the desired level of dispensing accuracy, the substrate on the substrate mount should be oriented parallel to dispensing device on the y-axis. The positioning of the substrate mount relative to the dispensing device is accomplished using optical systems, which comprise at least one, and in some optical systems, more than one image sensor. Usually, an optical system is employed for positioning the substrate mount along the y-axis as described above. In this instance the optical system usually comprises at least two image sensors. An optical system is employed for positioning the dispensing device along the x-axis. In this instance the optical system usually comprises at least one image sensor. Thus, the optical systems are cooperative to position the dispensing device and the substrate mount relative to one another. Usually, the image sensor is part of a camera.

In some embodiments the components of the apparatus may be mounted on a suitable frame in a manner consistent with the present invention. The frame of the apparatus is generally constructed from a suitable material that gives structural strength to the apparatus so that various moving parts may be employed in conjunction with the apparatus. Such materials for the frame include, for example, metal, lightweight composites, granite and the like.

The apparatus, in some embodiments, may comprise a loading station for loading reagents into the dispensing device and a mechanism for moving the dispensing device and/or the loading station relative to one another. In some embodiments, the apparatus may also comprise a cleaning station or a washing station for cleaning or washing the dispensing device or surfaces of the dispensing device and a mechanism for moving the dispensing device and/or the cleaning or washing station relative to one another. In some embodiments the apparatus further may comprise a mechanism for inspecting the reagent deposited on the surface of the substrate.

The substrate mount may be any convenient structure on which the substrate may be placed and held for depositing reagents on the surface of the substrate. The substrate mount may be of any size and shape and generally has a shape similar to that of the substrate as long as it is sufficiently able to support the substrate. For example, the substrate mount may be rectangular for a rectangular substrate, circular for a circular substrate and so forth. The substrate mount may be constructed from any material of sufficient strength to physically receive and hold the substrate during the deposition of reagents on the substrate surface as well as to withstand the rigors of movement in one or more directions. Such materials include metals, plastics, composites, and the like.

The substrate may be retained on the substrate mount by gravity, friction, vacuum, and the like. The surface of the substrate mount, on which the substrate is received, may be flat. On the other hand, the surface of the substrate mount may comprise certain structural features such as, for example, parallel upstanding linear ribs, and the like, on which the substrate is placed. Whether the substrate mount is flat or comprises structural features, the resulting surface of the substrate mount on which the substrate rests is planar. The nature and number of structural features is generally determined by the size, weight and shape of the substrate, and so forth. In one embodiment the upper surface of the substrate mount has openings that communicate with a suitable vacuum source to hold the substrate on the substrate mount. The openings may be in the surface of the substrate mount or in structural features on the surface of the substrate mount. In a specific embodiment the substrate mount is a vacuum chuck.

In some embodiments the substrate mount is adapted for movement along certain axes such as, for example, translation along a y-axis and/or for rotation about a center axis that is parallel to a z-axis. Translation along a y-axis provides for moving a substrate on the substrate mount in position for dispensing of reagents to a surface of the substrate. Usually, this requires that the surface of the substrate be parallel to the surface of the dispensing device on which dispensing nozzles are located. Accordingly, the surface of the substrate is normal to the direction in which fluid is dispensed to the surface of the substrate. The ability of the substrate to rotate about a central axis allows any optical system, as discussed below, associated with the substrate mount to provide accurate orientation of the substrate with respect to a dispensing device during the dispensing of reagents to the surface of the substrate.

In one exemplary approach the substrate mount is carried by a stage arrangement, which provides for the desired movement parameters independently of the movement of the dispensing device. In this approach the substrate mount is secured to the stage, which is usually attached to a frame member of the apparatus. For example, the substrate mount may be carried by a stacked Increment-Theta stage arrangement that is attached directly to a granite base. Other approaches for providing the substrate mount with desired movement capabilities may be employed.

In the description herein the terms “x-axis,” “y-axis” and “z-axis” reference distinct axes and, preferably, a coordinate system that is orthogonal, i.e., a Cartesian coordinate system.

In some embodiments the drop dispensing module is adapted for translation along an x-axis independently of the movement of the substrate mount along the y-axis. Translation along an x-axis provides for moving the drop-dispensing module transversely to the direction of movement of the substrate mount (along the y-axis) and in position for dispensing of reagents to the surface of a substrate. In one approach the drop dispensing module is carried by a stage arrangement, which provides for the desired movement parameters. In this approach the drop dispensing module is secured to the stage, which is usually attached to a frame member of the present apparatus. For example, in one approach the drop dispensing module may be carried by an orthogonal z-axis stage arrangement attached to an x-axis stage arrangement, which is attached directly to a rigid supporting granite beam off a granite base to which the substrate mount is secured. Other approaches for providing the drop-dispensing module with desired movement capabilities may be employed.

In some embodiments to achieve the desired level of dispensing accuracy, the substrate on the substrate mount is oriented parallel to dispensing device on the y-axis. In some embodiments positioning of the substrate mount relative to the dispensing device is accomplished using optical systems, which comprise at least one, and in some optical systems, more than one image sensor. Usually, an optical system is employed for positioning the substrate mount along the y-axis as described above. Usually, the image sensor is part of a camera.

In some embodiments the present apparatus may also comprise a delivery device for delivering the substrate to the substrate mount. The delivery device has the function of receiving or removing a substrate from a substrate supply device and transporting the substrate to the substrate mount. Thus, the delivery device may have any convenient configuration, as long it is able to carry out the above functions. In one embodiment the delivery device is in the form of a two-prong fork where the supporting members (or prongs) of the fork are adapted to receive and carry the substrate. Usually, the prongs are designed to engage the underside surface of the substrate at the perimeter of the substrate. The delivery device may be made of any material that has the structural strength to carry the substrate and withstand the transport functions of the delivery device. Such materials include, for example, metals, lightweight composites, and so forth. The substrate may be retained on the substrate mount by gravity, friction, vacuum, and the like. In one embodiment the upper surface of the substrate mount has openings that communicate with a suitable vacuum source to hold the substrate on the substrate mount. The openings may be in the surface of the substrate mount or in structural features or support members on the surface of the substrate mount.

Another function of the delivery device is to deliver the substrate to the substrate mount so that preliminary adjustments may be made to provide the substrate to the substrate mount in a desired predetermined orientation. In this way the optical system of the substrate mount needs only to fine tune the orientation thereby achieving the desired predetermined orientation of the substrate relative to the dispensing device. To this end, the delivery device has associated therewith a delivery device optical system for positioning the substrate along an x-axis and a y-axis. The optical system may be similar in design to that discussed above for the substrate mount optical system. Thus, the delivery device optical system may comprise at least one image sensor. The delivery device is capable of translation along an x-axis and a y-axis and also is rotatable about a center axis so that the image sensors may communicate to a computer, which in turn may communicate with a mechanism such as a motor and the like that is responsible for the movement of the delivery device, to correct for deviations from the predetermined orientation for the substrate on the delivery device. Other configurations for the delivery device may also be employed.

In some embodiments the apparatus of the present invention may also comprise a loading station for loading reagents into the dispensers of the drop dispensing modules. The loading station may be positioned in the present apparatus in a manner similar to that of a cleaning or washing station. Accordingly, in some embodiments the loading station may be placed in line with a cleaning or washing station so that it moves transversely with respect to the drop-dispensing module, which moves on an x-axis. Other arrangements are also possible and will be suggested to those skilled in the art. The loading station may be of any convenient structure as long as the function of filling the dispensers of the drop-dispensing module with reagents to be dispensed is accomplished. The loading station may comprise appropriate controls for controlling the temperature, humidity and the like of the components of the loading station including the reagents contained therein. The loading station also may comprise appropriate circuitry and motors for controlling the movement of the loading station parallel to the x-axis. An example of an embodiment of a suitable loading station, by way of illustration and not limitation is described in U.S. Pat. No. 6,689,323, the relevant disclosure of which is incorporated by reference.

In some embodiments the present apparatus may also comprise a mechanism and method for accurately and rapidly observing deposition of droplets of liquid on the surface of a substrate. One such mechanism and method is described in U.S. Pat. No. 6,232,072 B1, issued May 15, 2001 (Fisher). The method includes depositing droplets of fluid carrying a biopolymer or a biomonomer on a front side of a transparent substrate. Light is directed through the substrate from the front side, back through a substrate back side and a first set of deposited droplets on the first side to an image sensor. In this manner, the first set is “imaged”.

In some embodiments the apparatus may also comprise a cleaning or washing station. Depending on the nature of the dispensers, this cleaning or washing may involve wiping the nozzle area of the dispensers or may involve a washing of the nozzle area and/or the dispensers.

As mentioned above, the apparatus and the methods in accordance with the present invention may be automated. To this end the apparatus of the invention further comprise appropriate motors and electrical and mechanical architecture and electrical connections, wiring and devices such as timers, clocks, computers and so forth for operating the various elements of the apparatus. Such architecture is familiar to those skilled in the art and will not be discussed in more detail herein.

To assist in the automation of the present process, the functions and methods may be carried out under computer control, that is, with the aid of a computer and computer program. For example, an IBM® compatible personal computer (PC) may be utilized. The computer is driven by software specific to the methods described herein. Software that may be used to carry out the methods may be, for example, Microsoft Excel or Microsoft Access and the like, suitably extended via user-written functions and templates, and linked when necessary to stand-alone programs that perform other functions.

Another aspect of embodiments of the present invention is a computer program product comprising a computer readable storage medium having a computer program stored thereon which, when loaded into a computer, performs the aforementioned method and/or controls the functions of the aforementioned apparatus.

### Specific Embodiments of Apparatus

Some embodiments of the present invention are directed to apparatus for preparing an array of polymeric compounds on a substrate from multiple polymer subunits. The apparatus comprise (a) two or more drop dispensing modules wherein at least two of the drop dispensing modules consist no more than six dispensers for dispensing a respective polymer forming reagent and (b) a module moving mechanism adapted to move the drop dispensing modules relative to a surface of a substrate on the substrate mount to bring each of the drop dispensing modules into drop dispensing relationship with the surface. In some embodiments, the apparatus comprises a substrate mount and a substrate moving mechanism adapted to move the substrate to a processing station and back to the substrate mount. In some embodiments the module moving mechanism is adapted to move the drop dispensing modules relative to a surface of a substrate on the substrate mount to bring each of the drop dispensing modules into drop dispensing relationship with the surface.

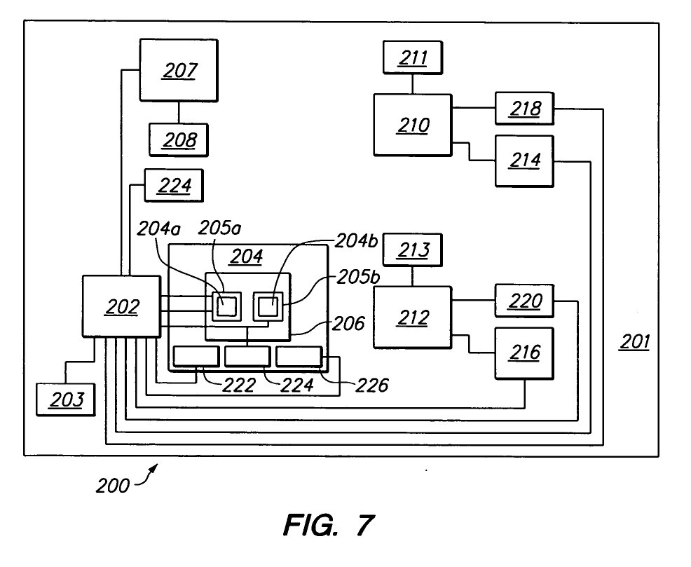

FIG. 7 depicts schematically an apparatus in accordance with embodiments of the present invention. Apparatus 200 comprises platform 201 on which the components of the apparatus are mounted. Apparatus 200 comprises main computer 202, with which various components of the apparatus are in communication. Video display 203 is in communication with computer 202. Apparatus 200 further comprises print chamber 204, which is controlled by main computer 202. The nature of print chamber 204 depends on the number of drop dispensing modules and the like. Within print chamber 204 are drop dispensing modules 204a and 204b (each comprising six dispensers, not shown) and module moving mechanism 205a and 205b, which are adapted to move drop dispensing modules 204a and 204b relative to a surface of a substrate on substrate mount 206 to bring each of the drop dispensing modules into drop dispensing relationship with the surface. Transfer robot 207 is also controlled by main computer 202 and comprises a robot arm 208 that moves a substrate to be printed from print chamber 204 to either first flow cell assembly 210 or second flow cell assembly 212. First flow cell assembly 210 is in communication with program logic controller 214, which is controlled by main computer 202, and second flow cell 212 is in communication with program logic controller 216, which is also controlled by main computer 202. First flow cell 210 assembly is in communication with fluid dispensing station 211 and flow sensor and level indicator 218, which are controlled by main computer 202, and second flow cell assembly 212 is in communication with fluid dispensing station 213 and flow sensor and level indicator 220, which are also controlled by main computer 202. Camera 222 is in communication with main computer 202.

Apparatus 200 also comprises loading station 224, which can be of any construction with regions that can retain small volumes of different fluids for loading into dispensers of droplet dispensing modules 204a and 204b. Loading station 224 may comprise a plurality of depots, from which liquids are to be transferred to dispensers of drop dispensing modules 204a and 204b. Loading station 204 is in fluid communication with dispensing modules 204a and 204b. A motor system (not shown), controlled by computer 202, can be operated to move loading station 224 so that loading station 224 may be moved into position under dispensing modules 204a and 204b to load the dispensers with respective reagent fluids.

Apparatus 200 may optionally comprise a cleaning station or wash station 226. Cleaning station or wash station 226 may be employed, for example, to wipe or wash the surfaces of the dispensers and, optionally, subsequently dry the surfaces of the dispensers.

Apparatus 200 further comprises appropriate electrical and mechanical architecture and electrical connections, wiring and devices such as timers, clocks, and so forth for operating the various elements of the apparatus. Such architecture is familiar to those skilled in the art and will not be discussed in more detail herein.

### Use of Arrays

Arrays synthesized in accordance with embodiments of the present methods may be utilized in many diagnostic procedures in proteomics, genomics, and so forth.

For example, determining the nucleotide sequences and expression levels of nucleic acids (DNA and RNA) is critical to understanding the function and control of genes and their relationship, for example, to disease discovery and disease management. Analysis of genetic information plays a crucial role in biological experimentation. This has become especially true with regard to studies directed at understanding the fundamental genetic and environmental factors associated with disease and the effects of potential therapeutic agents on the cell. Such a determination permits the early detection of infectious organisms such as bacteria, viruses, etc.; genetic diseases such as sickle cell anemia; and various cancers. This paradigm shift has lead to an increasing need within the life science industries for more sensitive, more accurate and higher-throughput technologies for performing analysis on genetic material obtained from a variety of biological sources.

Unique or misexpressed nucleotide sequences in a polynucleotide can be detected by hybridization with a nucleotide multimer, or oligonucleotide, probe. Hybridization is based on complementary base pairing. When complementary single stranded nucleic acids are incubated together, the complementary base sequences bind to one another or pair to form double stranded hybrid molecules. These techniques rely upon the inherent ability of nucleic acids to form duplexes via hydrogen bonding according to Watson-Crick base-pairing rules. The ability of single stranded deoxyribonucleic acid (ssDNA) or ribonucleic acid (RNA) to form a hydrogen bonded structure with a complementary nucleic acid sequence has been employed as an analytical tool in molecular biology research. An oligonucleotide probe employed in the detection is selected with a nucleotide sequence complementary, usually exactly complementary, to the nucleotide sequence in the target nucleic acid. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present.

Direct detection of labeled target nucleic acid hybridized to surface-bound polynucleotide probes is particularly advantageous if the surface contains a mosaic of different probes that are individually localized to discrete, and often known, areas of the surface. Such ordered arrays containing a large number of oligonucleotide probes have been developed as tools for high throughput analyses of genotype and gene expression. Oligonucleotides synthesized on a solid substrate recognize uniquely complementary nucleic acids by hybridization, and arrays can be designed to define specific target sequences, analyze gene expression patterns or identify specific allelic variations. The arrays may be used for conducting cell study, diagnosing disease, identifying gene expression, monitoring drug response, determination of viral load, identifying genetic polymorphisms, analyzing gene expression patterns or identifying specific allelic variations, and the like.

In one approach, cell matter is lysed, to release its DNA as fragments, which are then separated out by electrophoresis or other means, and then tagged with a fluorescent or other label. The resulting DNA mix is exposed to an array of oligonucleotide probes, whereupon selective binding to matching probe sites takes place. The array is then washed and examined or interrogated to determine the extent of hybridization reactions. Arrays of different chemical compounds or moieties or probe species provide methods of highly parallel detection, and hence improved speed and efficiency, in assays. Assuming that the different sequence polynucleotides were correctly deposited in accordance with the predetermined configuration, then the observed binding is indicative of the presence and/or concentration of one or more polynucleotide components of the sample.

Any suitable examining approach may be utilized. The nature of the examining device including a detector for examining the array for the results of one or more chemical reactions is dependent on the nature of the chemical reactions including any label employed for detection, such as fluorescent as mentioned above, chemiluminescent, colorimetric based on an attached enzyme, and the like. As mentioned above, the examining device may be a scanning device involving an imaging system or optical system. Other known examining devices may be employed. Such devices may involve the use of other optical techniques (for example, optical techniques for detecting chemiluminescent or electroluminescent labels) or electrical techniques (where each feature is provided with an electrode to detect hybridization at that feature in a manner disclosed in U.S. Pat. Nos. 6,221,583 and 6,251,685, and elsewhere). Other examining techniques include visual inspection techniques, non-light based methods, and so forth.

The signal referred to above may arise from any moiety that may be incorporated into the sample being analyzed for the purpose of detection. Often, a label is employed, which may be a member of a signal producing system. The label is capable of being detected directly or indirectly. In general, any reporter molecule that is detectable can be a label. Labels include, for example, (i) reporter molecules that can be detected directly by virtue of generating a signal, (ii) specific binding or reacting pair members that may be detected indirectly by subsequent binding or reacting to a cognate that contains a reporter molecule, (iii) mass tags detectable by mass spectrometry, (iv) oligonucleotide primers that can provide a template for amplification or ligation, (v) specific labeled nucleotide monomers which are incorporated into the target samples by enzymatic or chemical incorporation means, and (vi) a specific polynucleotide sequence or recognition sequence that can act as a ligand such as for a repressor protein, wherein in the latter two instances the oligonucleotide primer or repressor protein will have, or be capable of having, a reporter molecule and so forth. The reporter molecule can be a catalyst, such as an enzyme, a polynucleotide coding for a catalyst, promoter, dye, fluorescent molecule, chemiluminescent molecule, coenzyme, enzyme substrate, radioactive group, a small organic molecule, amplifiable polynucleotide sequence, a particle such as latex or carbon particle, metal sol, crystallite, liposome, cell, etc., which may or may not be further labeled with a dye, catalyst or other detectable group, a mass tag that alters the weight of the molecule to which it is conjugated for mass spectrometry purposes, and the like.

The signal may be produced by a signal producing system, which is a system that generates a signal that relates to the presence or amount of a target polynucleotide in a medium. The signal producing system may have one or more components, at least one component being the label. The signal producing system includes all of the reagents required to produce a measurable signal. The signal producing system provides a signal detectable by external means, by use of electromagnetic radiation, desirably by visual examination.

The arrays prepared as described above are particularly suitable for conducting hybridization reactions. Such reactions are carried out on an array comprising a plurality of features relating to the hybridization reactions. The array is exposed to liquid samples and to other reagents for carrying out the hybridization reactions. The substrate surface exposed to the sample is incubated under conditions suitable for hybridization reactions to occur.

After the appropriate period of time of contact between the liquid sample and the array, the contact is discontinued and various processing steps are performed. Following the processing step(s), the array is moved to an examining device as discussed above where the array is interrogated.

Results from the reading may be raw results (such as fluorescence intensity readings for each feature in one or more color channels) or may be processed results such as obtained by rejecting a reading for a feature that is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

When one item is indicated as being “remote” from another, this means that the two items are at least in different buildings and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

All publications and patent applications cited in this specification are herein incorporated by reference as if each individual publication or patent application were specifically and individually indicated to be incorporated by reference, except insofar as they may conflict with those of the present application (in which case the present application prevails). Methods recited herein may be carried out in any order of the recited events, which is logically possible, as well as the recited order of events.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A method for preparing an array of polymeric compounds on a substrate, said method comprising:
(a) dispensing drops of polymer forming reagents to a surface of a substrate from two or more drop dispensing modules comprising dispensers, each dispenser for dispensing a polymer forming reagent wherein each of the modules and the substrate are brought into drop dispensing relationship prior to step (b) in at least one step (a),
(b) subjecting the surface to reagents to prepare the surface for repeating step (a), and
(c) repeating steps (a) and (b) to prepare the array of polymeric compounds.

2. A method according to claim 1 wherein the polymeric compounds are biopolymers.

3. A method according to claim 1 wherein the polymeric compounds are polymers comprising polymer subunits selected from the group consisting of nucleotides and analogs thereof, amino acids and analogs thereof, and combinations thereof.

4. A method according to claim 1 wherein the polymer forming reagents comprise nucleotides and analogs thereof and two drop dispensing modules are employed.

5. A method according to claim 1 wherein the polymer forming reagents comprise amino acids and analogs thereof and five drop dispensing modules are employed.

6. A method according to claim 1 wherein the substrate is placed in a flow cell to carry out step (b).

7. A method according to claim 1 wherein arrays are prepared on at least two separate substrates and wherein in step (a) a dispensing protocol is employed in which one drop dispensing module dispenses polymer forming reagents to the surface of one of the substrates while the other drop dispensing module dispenses polymer forming reagents to the other of the substrates and then the dispensing protocol is reversed prior to step (b).

8. A method according to claim 1 wherein arrays are prepared on multiple substrates and a dispensing protocol is employed wherein drop dispensing modules are brought into dispensing relationship with respective substrates to dispense polymer forming reagents and the dispensing protocol is repeated until all polymer forming reagents are deposited for a particular step (a).

9. A method according to claim 1 wherein at least two of the drop dispensing modules consist of no more than six dispensers.

10. An apparatus for preparing an array of polymeric compounds on a substrate from multiple polymer subunits, said apparatus comprising two or more drop dispensing modules, each of the drop dispensing modules comprising dispensers for dispensing a respective polymer forming reagent.

11. An apparatus according to claim 10 wherein at least two of the drop dispensing modules consist of no more than six dispensers.

12. An apparatus according to claim 10 further comprising a substrate mount and a substrate moving mechanism adapted to move the substrate to a processing station and back to the substrate mount.

13. An apparatus according to claim 10 comprising two substrate mounts wherein the module moving mechanism is adapted to move the drop dispensing modules in a dispensing protocol in which one drop dispensing module dispenses polymer forming reagents to the surface of one of the substrates while the other drop dispensing module simultaneously dispenses polymer forming reagents to the other of the substrates and then the dispensing protocol is reversed.

14. An apparatus according to claim 13 further comprising a loading station for loading polymer forming reagents into respective dispensers of the drop dispensing modules.

15. An apparatus according to claim 14 further comprising a mechanism for moving the drop dispensing modules and/or said loading station relative to one another.

16. An apparatus according to claim 10 further comprising the processing station.

17. An apparatus according to claim 16 wherein the processing station comprises a flow cell.

18. An apparatus according to claim 10 further comprising a computer in communication with the drop dispensing modules and the module moving mechanism and a computer program product for controlling the drop dispensing modules and the movement of the module moving mechanism.

19. An apparatus according to claim 10 wherein each of the dispensers of the drop dispensing modules comprise a different polymer forming reagent selected from the group consisting of nucleotides and analogs thereof, amino acids and analogs thereof, and combinations thereof.

20. An apparatus according to claim 10 wherein the apparatus is adapted to establish a drop dispensing relationship among the drop dispensing modules and the different substrates, to simultaneously dispense polymer forming reagents from the drop dispensing modules to the different substrates and to establish another drop dispensing relationship among the drop dispensing modules and the different substrates until all polymer forming reagents are deposited for a particular step of preparing an array.

21. An apparatus according to claim 10 comprising two of the drop dispensing modules wherein each module consists of 5 to 6 dispensers.

22. An apparatus according to claim 10 comprising five of the drop dispensing modules wherein at least two modules consist of 5 to 6 dispensers.

23. An apparatus according to claim 10 further comprising a module moving mechanism adapted to move the drop dispensing modules relative to a surface of a substrate to bring each of the drop dispensing modules into drop dispensing relationship with the surface.

24. A method for preparing an array of polymeric compounds on a substrate from multiple polymer subunits, said method comprising:
(a) dispensing drops of polymer forming reagents to a surface of a substrate from two or more drop dispensing modules wherein at least two of the modules consist of no more than six dispensers for dispensing a respective polymer forming reagent and wherein each of the modules and the substrate are brought into drop dispensing relationship prior to step (b) in at least one step (a),
(b) subjecting the surface to reagents to prepare the surface for repeating step (a), and
(c) repeating steps (a) and (b) to prepare the array of polymeric compounds.

25. An apparatus for preparing an array of polymeric compounds on a substrate from multiple polymer subunits, said apparatus comprising:
(a) two or more drop dispensing modules wherein at least two of the drop dispensing modules consist of no more than six dispensers for dispensing a respective polymer forming reagent, and
(b) a module moving mechanism adapted to move the drop dispensing modules relative to a surface of a substrate to bring each of the drop dispensing modules into drop dispensing relationship with the surface.
